(19) United States
(12) Patent Application Publication
(10) Pub. No.: US 2009/0095351 A1
(43) Pub. Date: Apr. 16, 2009

(54) PIPELINE ADDITIVE CONTROL DEVICE AND METHOD

(75) Inventors: DOUGLAS CHRISTIAN GREENING, Calgary (CA); SEBASTIEN TAYLOR, Calgary (CA); ANTHONY ROBERT BASTIAANSEN, Calgary (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(73) Assignee: BOSS PACKAGING INC., Calgary (CA)

(21) Appl. No.: 12/174,524

(22) Filed: Jul. 16, 2008

Related U.S. Application Data
(60) Provisional application No. 60/950,063, filed on Jul. 16, 2007.

(51) Int. Cl. F17D 3/12; B01F 5/04

(52) U.S. Cl. 137/3; 137/897

(57) ABSTRACT

A pipeline additive injection system including: an injection pump for injecting an amount of additive into a pipeline; a battery for powering the injection pump; system sensors to monitor system conditions; and a controller for retrieving system data from the system sensors and for controlling operation of the injection pump based on the system data to achieve additive injection compensation.

### FIELD

The present invention relates to a pipeline additive control device and method.

### BACKGROUND

In pipeline conveyance of fluids, antifreeze is sometimes added to the pipeline fluids to prevent freezing. Other additives may also from time to time be injected into pipelines. Such other additives may include test fluids, anti-waxing fluids, anticorrosion fluids, etc. In some current systems, additives are continuously added at regular intervals, the length of an interval being preset or manually adjusted by an operator.

With such a system, additives may be wasted as they are added even when it is unnecessary to do so. On the other hand, the pipeline conditions may be at risk when the system delays additive injection beyond that period most appropriate based on the current conditions.

In remote locations additive flow control devices may be battery or solar operated and may be difficult to reach for refilling and manual adjustment. Therefore, effective use of additive quantities and system power may be particularly of interest.

### SUMMARY

In accordance with a broad aspect of the invention, there is provided a pipeline additive injection system comprising: an injection pump for injecting an amount of additive into a pipeline; a battery for powering the pump; system sensors to monitor system conditions; and a controller for retrieving system data from the system sensors and for controlling operation of the injection pump based on the system data to achieve additive injection compensation.

In accordance with another broad aspect of the invention, there is provided a pipeline additive injection system comprising: an injection pump for injecting an amount of additive into a pipeline; a battery for powering the pump; a power system sensor for monitoring power system data from the battery; a controller for retrieving battery system data from the power system sensor and for controlling operation of the injection pump based on the battery system data.

In accordance with another broad aspect of the invention, there is provided a method for injecting additives to a pipeline, the method comprising: providing an additive injection system; monitoring pipeline, environmental and system conditions to obtain representative data; analyzing the representative data to formulate a routine for additive injection.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the description, drawings and detailed description of illustrated embodiments are to be regarded as illustrative in nature and not as restrictive.

### DESCRIPTION

An automated flow control device may be useful for controlling the addition of pipeline additives to a pipeline. An automated flow control device may include a pump and a controller for operating the pump, the controller being controlled based on monitored data. Monitored data may include a time-based data such as time of day and/or calendar time, environmentally-based data such as actual temperature and/or weather conditions, forecasted temperature and/or weather conditions, fluid conditions including presence of water or chemicals of interest (i.e. corrosive chemicals) etc.

The device, in some embodiments, may also include a power supply if one is not available in the desired installation location. The power supply may for example include solar panels, wind generators, batteries, etc.

The pump may take various forms. For example, the pump may be electrically or pressure driven.

The controller may include any or all of: a real time clock for time based monitoring, a temperature sensor for temperature monitoring, communications device for receiving temperature/weather data including real time and/or forecasted data, pipeline fluid content sensors for pipeline fluid conditions including water content, presence of corrosive fluids, vibration sensors for monitoring pipeline conditions, etc.

The controller may also or alternatively control additive injection based on power usage criteria, including power availability, motor rotation (to detect low power conditions), etc. This may allow power management, which may be useful in battery or solar powered systems where power consumption may be considered with respect to temperature, amount of daylight, cloudy days, the time of the year, battery or motor function. This being useful to protect battery life, avoid battery failure and, for example, to consider the availability of recharging conditions for solar (i.e. appropriately handle the occurrence of cloudy days or long nights, etc.).

The controller may therefore operate the pump to inject additives to the pipeline at a rate corresponding to need and/or to manage power consumption.

In some systems, metering may be of interest to maintain a set volume of injected fluid regardless of system conditions. For example, when using battery operation, if a motor on/motor off timed interval is used some pumps may inject lower volumes of fluids as a battery starts to lose power. Pump motor rotation monitoring may be used to provide reliable volume metering for a pump. In one embodiment of the present device, motor rotation may be monitored and used to provide true metering. For example, motor rotation sensors such as encoders, those based on magnetic sensing, etc. may be used and monitored by the system to provide true metering.

The device may include software, etc. for control, as will be appreciated. The device may also include features such as any of: a memory, an operator interface such as a keypad, touch screen, display, etc., a communications port for uploading and downloading data, etc.

### BRIEF DESCRIPTION OF THE DRAWINGS

Referring to the drawings, several aspects of the present invention are illustrated by way of example, and not by way of limitation, in detail in the figures, wherein:

FIG. 1 is a schematic view of a pipeline additive system installed on a pipeline.

FIG. 2 is a schematic functional diagram of a controller useful in a pipeline additive system.

FIG. 3 is a schematic view of a pipeline additive system installed on a pipeline.

FIG. 4 is a flowchart showing a method of adding additive to a pipeline.

### DETAILED DESCRIPTION OF ILLUSTRATED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

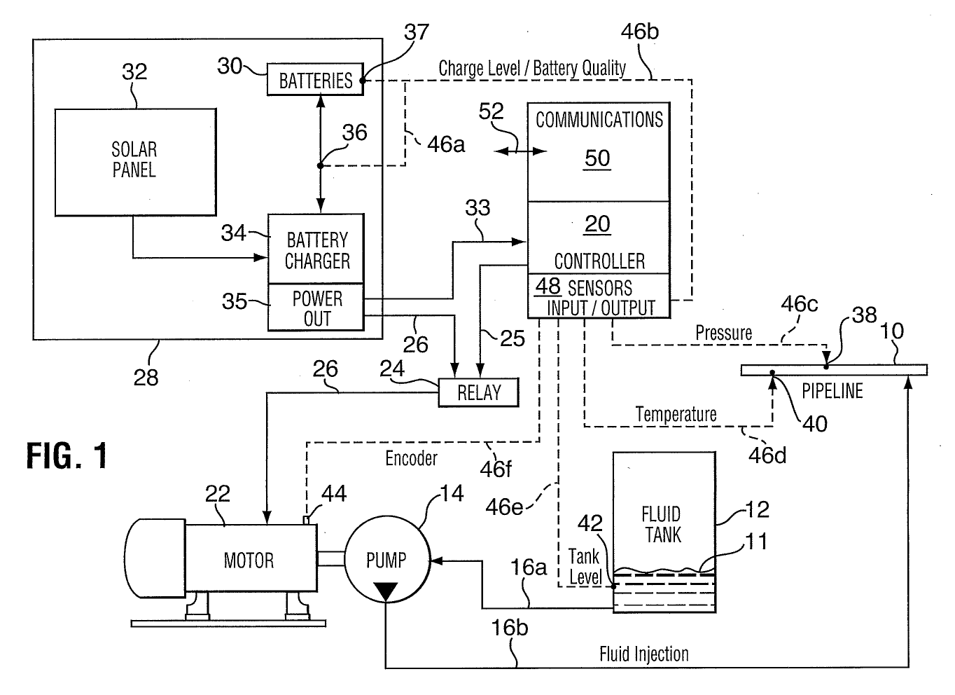

Referring to FIG. 1, a pipeline additive system is shown installed on a pipeline 10. The system is capable of periodically introducing a pipeline fluid additive 11 from a tank 12 to the pipeline. The system, in this illustrated embodiment, includes an electrically driven injection pump 14 which draws fluid additive from tank 12 and passes the fluid through a line 16a, 16b to inject the fluid into the pipeline. The system further includes a controller 20 that monitors data relating to the pipeline, additive, environmental conditions and/or system conditions and controls the operation of injection pump 14 based on the monitored data.

Injection pump 14 is driven by a motor 22 controlled by controller 20, as by use of a relay 24 or other power regulator. Relay 24, as controlled 25 by controller 20, may connect or disconnect supply lines 26 from a power supply 28 to motor 22. As in the illustrated embodiment, power supply 28 may for example include batteries 30, a power generator such as a solar panel 32, battery charger 34 and power output 35. Power supply 28 may also provide power to controller 20, as through line 33.

Controller 20 may operate with sensors such as any or all of: a solar panel charging voltmeter 36, a battery voltage/quality indicator 37 such as an analog battery voltage meter, a pipeline pressure sensor 38, a pipeline contents temperature sensor 40, a fluid level sensor 42 and a pump motor encoder 44. Controller 20 communicates with the sensors through connections 48 and wired or wireless communications 46a to 46f. As such, the controller effectively is able to determine operational data relating to any of the system conditions such as additive supply via sensor 42, power availability through voltmeter 34 and indicator 36, pipeline contents conditions such as flow pressure and temperature via sensors 38 and 40 and motor condition such as power usage or motor drive rotation speed applicable to injected additive volume metering, as by use of encoder 44 with or without considering fluid compressibility, pipeline and additive temperature, pipeline pressure and pump efficiency.

Controller 20 may further communicate with external systems through a data communications system 50. System 50 may provide wired or wireless communications 52 for external control of controller 20, and thereby the additive system as a whole, external data collection and/or may allow data collected by the controller to be sent to offsite systems.

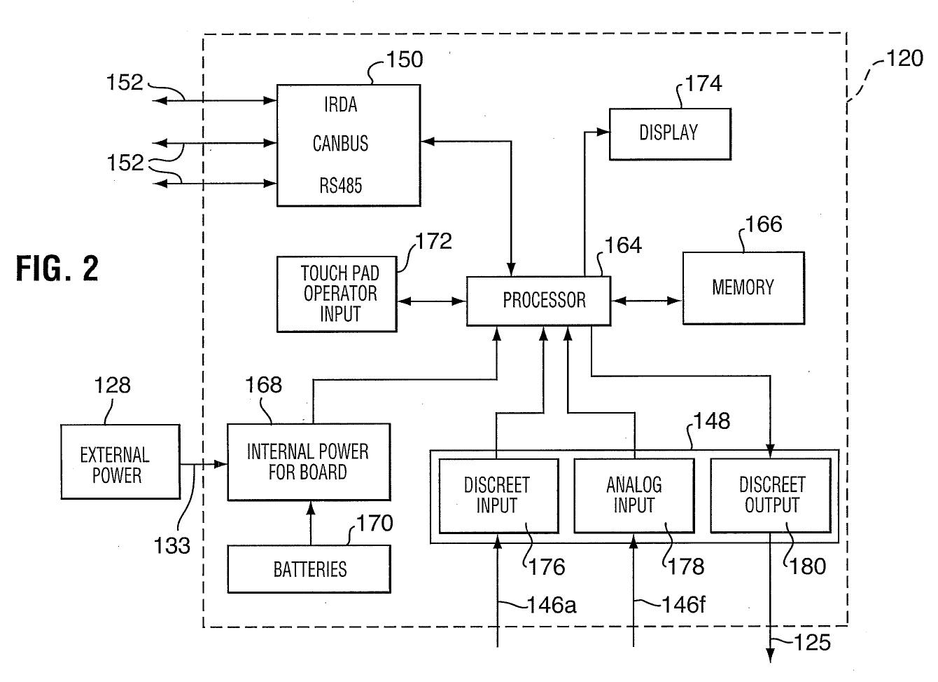

In one embodiment, such as that shown in FIG. 2, a controller 120 may be employed which includes input and outputs in interfaces 148 suitable for communicating with various sensors and a data communication system 150. As an example, one useful controller may be a BossPac Bluebox™ Controller, available from the assignee of this application. Such a controller may include one or more devices and/or electronics such as for example, a processor 164, a memory 166, an internal power supply system including a power conditioner 168 and batteries 170, user interfaces such as user input selectors 172 and/or a display 174, as well as external component interfaces 148 and data communication system 150.

Processor 164 may be a central processing unit, programmable logic controller, digital signal processor, etc. that controls the general operation of the system including the receipt and processing of data and the output of signals and information based on the data. For example, processor 164 may also include a function for receiving data from sensor interfaces through discreet and analog inputs 176, 178 and communicating with the relay for pump operation control through relay discreet output 180. Processor 164 may further include a timer, clock and/or calendar functionality in order to provide any or all of timing controls for, for example, actuation of relays and management of operation frequency routines. Alternately or in addition, the clock and/or calendar functionalities may allow a time of day or season control protocol, as may be useful for forecasting power availability during periods of darkness. The processor can be programmed to carry out its various functions, as will be well understood by a person skilled in the art.

Processor 164 may receive signals from or sample the sensors, as through connections 146a, 146f and may filter and process data and may log data to on-board memory 166. Memory 166, for example, may include non-volatile RAM memory which will retain stored information even if power is removed from the system. A 16 or 32 megabit memory capability may be useful to allow data storage for later downloads and data analysis. Data may be stored as raw, time-based waveforms.

Data communications such as data transfer and external control inputs/outputs 152 can be achieved via data communication system 150. System 150 may include any communication protocols, as desired. For example, the system may support analog or digital communications including any or all communication protocols of CANBUS, IRDA, RS485, etc. In one embodiment, for example, IRDA protocol may provide wireless data transferring capabilities to allow uploads of data from memory even in a potentially hazardous environment.

Direct programming and control may be achieved by user input selectors 172 such as exterior control buttons, touch pads, keys, etc. Display 174 may be provided to allow instant user feedback at the controller. Display 134 may include a screen, indicator lights, audible signals, etc. In one embodiment, display 134 may include an organic light emitting diode screen such that it is able to operate at very low temperatures, such as at −40° C., and uses very little power.

On board power supply may include a power conditioner 168 for accepting and conditioning power from an external power supply 128, such as supply 28 of FIG. 1 or from on-board batteries 170. Since external power supply 128 may include a power generating device, such as a solar panel, power conditioner 168 may preferentially use power from external supply 128. Power from conditioner 168 may be provided to the processor and other components of controller 120. In any event, controller 120 may have very low power requirements, such as for example less than or equal to 120 milliamps, such that it works well in remote locations powered only by its internal battery and a solar charging power supply.

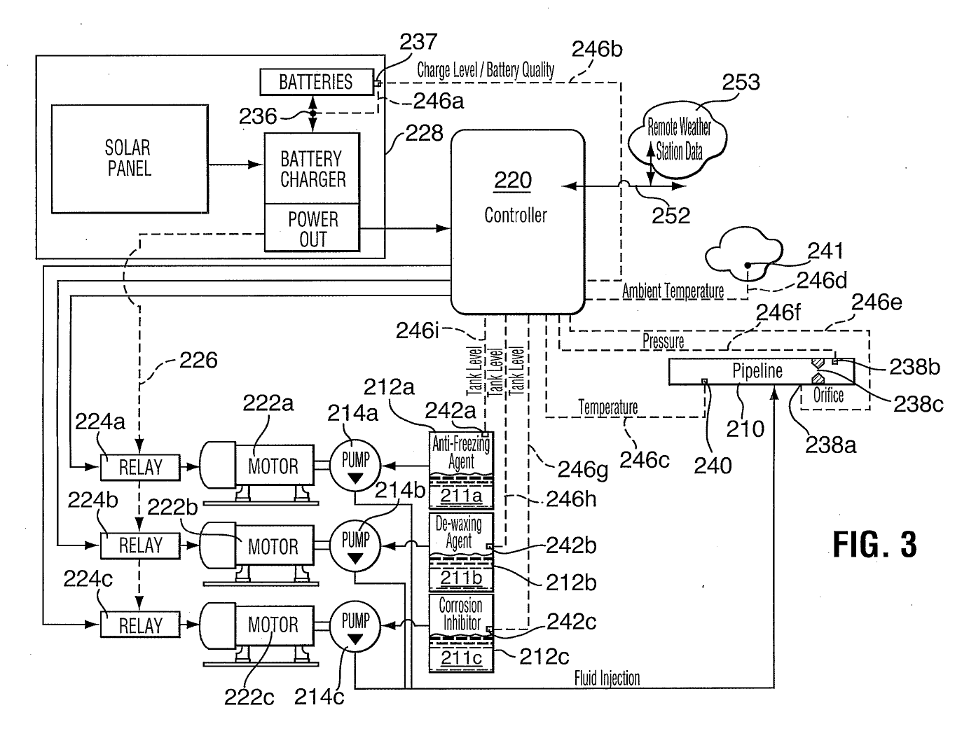

Referring to FIG. 3, another pipeline additive control system is shown. The system is capable of periodically introducing pipeline fluid additives to a pipeline 210. Although many features are similar to that system illustrated in FIG. 1, it is noted that a system according to the present invention may be useful to operate complex additive protocols such as including the injection of a number of additives to a pipeline based on a complex array of monitored conditions. For example by use of the system, additives such as anti-freezing agent 211a, de-waxing agent 211b, corrosion inhibitor 211c, etc. can be injected from supply tanks 212a, 212b, 212c, respectively, to the pipeline. Of course, other additives can be added separately from or mixed with these listed additives.

The system of FIG. 3 includes an injection pump 214a, 214b, 214c for conveying fluids from their tanks to the pipeline. The system further includes a controller 220 that monitors data relating to the pipeline, additive, environmental conditions and/or system conditions and controls the operation of each of the injection pumps to inject the appropriate additive at the appropriate time or frequency based on the monitored data. The injection pumps may be controlled in various ways by controller 220. In this illustrated embodiment, controller 220 actuates a relay 224a, 224b, 224c to power on or power off each pump's motor 222a, 222b, 222c by connecting and disconnecting each motor to a supply line 226 from the system's power supply 228. By this arrangement, each pump can be operated independently of each other pump such that selected amounts of the additives may be injected to the pipeline, when the controller deems it appropriate. Controller 220 uses a timer and known flow rate parameters for the pumps, i.e. motor rpm, to ensure an appropriate volume of additive is pumped at any particular time. Such a system assumes that variances based on pipeline flow rate, temperature of additive, have little effect on the pumped volume. If desired, an encoder can be employed to at least monitor motor rpm, to provide further control and feedback with respect to additive injection volumes.

Controller 220 may operate with sensors such as any or all of: a solar panel charging voltmeter 236, a battery voltage/quality indicator 237, a pipeline pressure sensor arrangement 238a, 238b, 238c, a pipeline contents temperature sensor 240 such as, for example, may include a thermocouple, an ambient environmental temperature sensor 241 such as may include a thermocouple and a fluid level sensor 242a, 242b, 242c for each tank.

Solar panel charging voltmeter 236 and battery indicator 237 provide data on power availability, which will determine the systems ability to continue to function. Pipeline pressure sensor arrangement includes pressure transducers 238a, 238b installed on the upstream and downstream sides respectively of an orifice 238c within the pipeline. A measured pressure differential from the transducers for a given sized orifice can be correlated to a predetermined fluid flow rate through the pipeline. As such, the controller effectively is able to determine operational data relating to any of the system conditions such as additive usage and supply via sensors 242a-c, power availability through voltmeter 234 and indicator 236, environmental conditions about the pipeline by sensor 241 and pipeline contents conditions such as flow rate and temperature via sensor system 238a-c and sensor 240, respectively.

Controller 220 communicates with the sensors through wired or wireless communications 246a to 246i. Controller 220 may further communicate with external systems through data communications components incorporated therein, the communications being through wired or wireless systems 252. Systems 252 and data communications capabilities may allow external control of controller 220, and thereby the additive system as a whole, and/or may allow data collected by the controller to be sent to offsite systems. Systems 252 and data communication capabilities may further allow receipt or acquiring data of relevance to the pipeline additive system such as data relating to weather conditions and/or forecasts such as including data from a remote weather station 253.

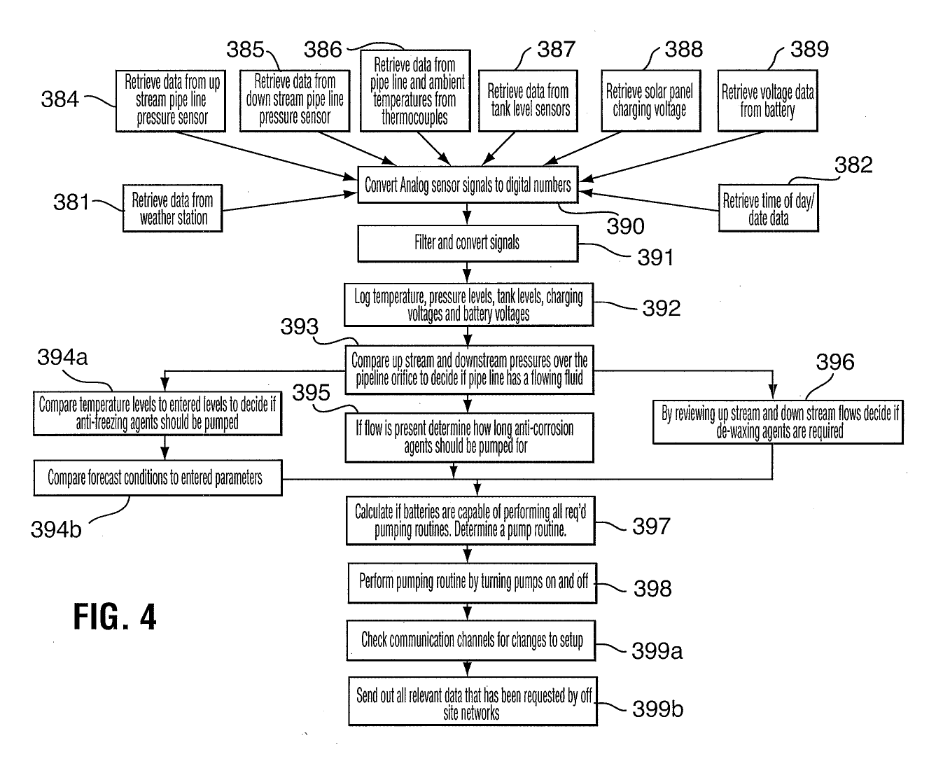

The system of FIG. 3 can be used to illustrate the operation of a pipeline additive system with reference also to FIG. 4. To employ the system, the components are installed including the injection pumps, tanks and injection lines to the pipeline. The controller, power system and sensors are also installed, the controller is connected for external data communication and the system is powered.

Thereafter, the controller can begin to retrieve data of interest to the system. For example, the processor, at any particular time, can do any or all of the following: receive 381 data concerning weather forecasts; receive 382 data relating to time of day and/or date, as from the controllers clock/calendar functions; receive 384 data from the upstream pressure transducer 238a, receive 385 data from downstream pressure transducer 238b, receive 386 data from the pipeline and ambient temperature sensors 240, 241, receive 387 data from the tank level sensors 242a-c, receive 388 data indicative of the solar panel charging voltage from voltmeter 236, and/or receive 389 data indicative of battery voltage and condition from sensor 237 such as an analog voltage meter. While receiving 386 data from the temperature thermocouples and receiving 387 data from the tank level sensors are each shown as a single step, it is to be understood that these steps include polling/receiving information from a plurality of sensors and such steps may, in fact, include one or multiple operations and one or more data sources. The controller can control the sampling/data retrieval rate.

Analog signals from the sensors may then be converted 390 to digital signals. If desired, this may be done adjacent the sensors before signal transmission such that signal degradation from communication of analog signals can be avoided.

At the processor, signals are filtered 391 to smooth the data, as by use of a rolling average, or other means which will be appreciated by a skilled person, etc. Thereafter, the sensor, weather and clock data is logged 392 to memory, such as to on-board memory of the system's controller.

In the illustrated embodiment, the controller then also can analyze the data from the sensors in order to control the pipeline additive system based thereon and/or to generate data for logging to memory. For example, the controller can do any of the following, in various orders as desired or as indicated:
Compare and analyze 393 upstream and downstream pressures sensed at steps 384, 385 and analyze such pressures with respect to the programmed orifice information to determine if the pipeline has a flowing fluid and the rate of such flow. This allows a determination as to whether there is any significant flow through the pipeline to determine whether any additive should be pumped and, if any is pumped, how much should be added. Because this can conserve additive by avoiding unnecessary injections into a non-flowing pipeline and assist with the determination of the appropriate quantity of additive, this may be a useful first step for many analyzing processes for pipeline additive injections.
Compare 394a temperatures sensed at step 386 to programmed set temperatures of interest to determine if temperature dependent pipeline additives, such as anti-freezing agent, should be injected into the pipeline. In one embodiment, the controller may be responsive to data obtained from either or both the ambient temperature sensor and the pipeline contents temperature sensor. Signals from either or both sensors are analyzed by the controller in order to determine whether there is a need for anti-freeze, for example whether relay 224a should be opened or closed to disallow or allow pumping of the additive. The controller can operate based on preselected and stored set temperatures of interest, such as a set low temperature of interest. The low temperature of interest may be selected to avoid the freezing of condensate in the pipeline. For example, the controller can be set to close relay to drive the pump continuously or with regular frequency any time one or both sensed temperatures fall below the set low temperatures of interest, such as, for example, may be 0° C. at thermocouple 240 or 5° C. at thermocouple 241. The controller can also be set with an upper temperature of interest such that the relay is not repeatedly opened and closed in response to small temperature fluctuations around the set temperatures, but will only open to cut power to the pump when the temperature increases beyond the set upper temperature of interest, such as for example may be 5° C. at thermocouple 240 or 10° C. at thermocouple 241. The set upper and lower temperatures may be preprogrammed, set/adjustable at controller 220 and/or externally set/adjustable, as is described hereinafter in step 399a. The determination as to whether any anti-freezing agent is required may be dependent on whether or not any flow of pipeline contents are sensed in step 393. Further the volume of anti-freezing agent injected to the pipeline, as may be determined by the frequency or duration of anti-freezing agent pump 214a operation, may be dependent on the rate of flow of pipeline contents.
Compare 394b weather forecast data obtained at step 381 to programmed set temperatures of interest or forecast data of interest to determine if temperature dependent pipeline additives, such as anti-freezing agent, should be injected into the pipeline. For example, with reference to the temperature analysis considerations noted above, the controller can compare forecast temperatures against the set temperatures of interest or monitor for weather conditions indicative of a sudden drops in temperature, to seek to initiate, or increase the rate of, addition of temperature dependent additives.
Based on the flow of pipeline contents, determine 395 how much anti-corrosion agent should be added. This may be simply a factor of whether or not there is a flow of pipeline contents detected at step 393 or may include a consideration of other data such as a review of pipeline contents, as from programmed information, a communication to external systems or data obtained from sensors (not shown) within the pipeline monitoring for the presence of corrosive chemicals. In one embodiment, the volume of anti-corrosion agent injected to the pipeline, as may be determined by the frequency or duration at which pump 214c is driven, may be dependent on the rate of flow of pipeline contents.
Based on the analysis of step 393, determine 396 if de-waxing agent is required. De-waxing agent may be required where wax build-ups threaten flow through the pipeline. For example, in determining whether de-waxing agent is required, the controller may analyse pipeline pressure conditions to decide whether a pressure build up or flow blockage is occurring. This analysis may be based on a comparison against historic flow data or programmed expected flow information.

The results of the various analyses may be logged to on-board memory.

After the analysis to determine the need for additives, the information and possibly some originally retrieved data can be further analyzed in one or more ways. For example, the system can calculate 397 whether the battery power is sufficient to perform all additive injections determined to be necessary in steps 394a, 394b, 395, 396 and determine what such a routine should be. Such calculations may be based on current power availability and possibly also forecasts of power availability. Current power availability may be considered to determine 397 whether a pumping routine for the required additives can be adequately supported. For example, the controller can calculate, based on the data obtained in steps 388, 389, whether the batteries are capable of supporting all pumping routines determined to be necessary in steps 394a, 394b, 395, 396 and the controller can further decide on a pumping routine to inject appropriate additives. This may be achieved by comparing data regarding solar panel charging voltage and battery voltage against programmed voltage or condition parameters of interest. In one embodiment, a programmed voltage of interest may be about 12 volts and if the data of step 389 indicates that the battery has a voltage of greater than about 12 volts the controller decides that the batteries are in good condition to support full operation. If the data of step 389 indicates that the battery voltage is less than 12 volts, then it may be determined that either the batteries or the solar charging circuit are not working properly. Data from step 388 can be used to further analyse the battery fault.

In any event, since battery condition may effect the system's ability to run the pumps, the determination 397 may consider data obtained in steps 388 or 389 and compare that battery condition against the power consumption requirements to operate the pumps according to the needs decided in steps 394a, 394b, 395, 396, as can be programmed to and calculated by the system. In one embodiment, if the data of step 389 indicates that the battery has a voltage at least according to that required for full system operation, the controller can proceed with a pump routine to achieve all injections. However, if the data of steps 388 or 389 indicate that the battery voltage is less than that needed to support the full power consumption requirements fulfill all of the requirements of steps 394a, 394b, 395, 396, then it may be determined that some or all additive injections cannot be performed at the frequency desired or at all. In such a case, a pump routine may be formulated by the controller based on prioritized operations. The controller can be preprogrammed, field programmed or controlled by external systems to prioritize the pump operations. For example, a user can select an additive of first priority, wherein if the power availability is such that only one pump can operate, then that first priority additive will be injected preferentially. The additives of second priority can either not be injected or be injected at reduced volumes or frequency. If it is determined that the power availability is such that even one selected injection pump cannot be operated at the selected rate/frequency, the controller can reduce pump operation and thereby injection of the additive to seek to avoid a complete failure to inject the additive. Based on the foregoing calculations and analysis, the controller can arrive at a suitable pump routine.

When calculating 397 power availability, forecasted power availability may also be of interest. For example, weather forecast information obtained in step 381 can be used to determine if there will be weather, such as cloudy conditions, that will adversely effect battery recharging. Alternately or in addition, time of day and/or date data obtained in step 382 can be reviewed to forecast period of darkness such as onset and length of night, which again will adversely effect battery recharging. Thus, calculating 397 can include reviewing forecast data from steps 381 and/or 382 to estimate the ability to operate the pumps according to the requirements of steps 394a, 394b, 395, 396 during non-charging periods such as nighttime or cloudy weather conditions. The foregoing is useful to develop a pump routine that can be supported by the power supply over a period while avoiding unexpected system shutdown due to battery failure.

Thereafter, the controller can operate the relays for each pump to achieve 398 the pumping routine developed in step 397. A pump routine can include the frequency and duration of operation for any particular pump. When a pump is powered by closing a relay, the pump runs at a typical flow rate, which can be recorded to the controller. Thus, to adjust flow of any pump, the length of time the pump is powered over a time period can be adjusted. If it is desired to inject a particular additive, it is generally desired to operate its pump at regular intervals such as in one minute cycles and adjust the operational time within that cycle to adjust the volume of additive injected to the pipeline.

From time to time at various points in the process, the data communication systems can provide for external control and/or output of data. For example, the controller can periodically check 399a or be programmed to alter the system set up. For example, the controller can receive instructions in respect of any or all of: discontinuing a particular additive addition, altering the temperatures of interest in step 394, altering the voltage or condition parameters of interest in step 397 to reduce power usage to conserve battery power, etc. Also or alternately, the controller can periodically send out 399b data to external systems, as requested or according to a programmed routine. Such data may be that logged in step 392 or from the analysis of steps 393 to 397. In one possible embodiment, for example, external systems may monitor the levels of additive in tanks or the condition of the batteries to determine when maintenance is required.

This method may be repeated continuously during operation of the additive injection system such that changes in conditions, such as temperature, pipeline flow rates, power availability, tank levels, etc. and changes in operating parameters, as by field or external resetting can be sensed and used to control operation of the injection protocol.

The previous description of the background and disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are know or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 1.12, sixth paragraph, unless the element is expressly recited using the phrase “means for” or “step for”.

We claim:

1. A pipeline additive injection system comprising: an injection pump for injecting an amount of additive into a pipeline; a battery for powering the injection pump; system sensors to monitor system conditions; and a controller for retrieving system data from the system sensors and for controlling operation of the injection pump based on the system data to achieve additive injection compensation.

2. A pipeline additive injection system comprising: an injection pump for injecting an amount of additive into a pipeline; a battery for powering the injection pump; a power system sensor for monitoring power system data from the battery; a controller for retrieving battery system data from the power system sensor and for controlling operation of the injection pump based on the battery system data.

3. A method for injecting additives to a pipeline, the method comprising: providing an additive injection system; monitoring pipeline, environmental and system conditions to obtain representative data; analyzing the representative data to formulate a routine for additive injection; and driving the additive injection system according to the formulated routine.
